(19) United States
(12) Patent Application Publication
(10) Pub. No.: US 2016/0365831 A1
(43) Pub. Date: Dec. 15, 2016

(54) PHOTOVOLTAIC MODULE

(71) Applicant: JOSEF JOACHIM GMEINER, Weiden (DE)

(72) Inventor: JOSEF JOACHIM GMEINER, Weiden (DE)

(21) Appl. No.: 15/120,834

(22) PCT Filed: Feb. 26, 2015
(86) PCT No.: PCT/EP2015/054071

§ 371 Date: Aug. 23, 2016

(30) Foreign Application Priority Data
Feb. 28, 2014 (DE) 10 2014 102 729.9

(51) Int. Cl. H02S 30/10; H02S 20/23

(52) U.S. Cl. CPC H02S 30/10; H02S 20/23

(57) ABSTRACT

A photovoltaic module includes a frame with profile struts and a composite fastened to the frame. The composite has a plurality of layers such as photovoltaic cells and a transparent layer located on the photovoltaic cells. A spacing device is fastened to the frame and mounted at a first distance from an upper side of the composite and at a second distance from an end face of the composite, so as to define, between the spacing device on the one hand and the upper side and end face on the other hand, a continuous path (28) through which water can drain. A related method of modifying an existing photovoltaic module is also enclosed.

### CROSS-REFERENCE TO RELATED APPLICATIONS

This application is a national stage of International Application No. PCT/EP2015/054071, filed Feb. 26, 2015, and claims benefit to German Patent Application No. 10 2014 102 729.9 filed Feb. 28, 2014, both of which are incorporated by reference herein.

### TECHNICAL FIELD

The present disclosure is generally related to photovoltaic modules having a spacing device to permit drainage.

### BACKGROUND

Photovoltaic modules encompass typically photovoltaic cells on which an EVA (ethylene vinyl acetate) layer and covering glass panel are applied. In most of the cases, a so-called Tedlar film with at least one polyvinyl fluoride (PVF) layer (a so-called back sheet) is provided on the underside, to protect the underside from environmental influences. In addition to having high UV-resistance, the Tedlar film serves to block humidity. On the side of the module, this composite consisting of cells, EVA layer, glass panel and Tedlar film is incorporated into a circumferential aluminum frame that generally includes four aluminum profile struts. A seal with a U-shaped cross-section is provided between the cell-EVS-glass panel-Tedlar composite and the frame.

In known photovoltaic modules, undesired delamination occurs relatively frequently, in which the above-mentioned composite made up of cells, EVS, glass panel and Tedlar film starts coming apart. The causes can be varied. For example, the seal can be or become defective, so that water—especially rainwater—can penetrate into the space between the composite and frame. As a result of this, a so-called ground fault can occur in which the solar current of the photovoltaic cell no longer flows through the connecting lines, but creates a conductive connection between one of the two conducting paths of the cells, either the positive or negative conductor, and the module frame. This scenario is life-threatening because when a hand touches the frame, this current flows through the body of the affected person.

If so much water penetrates through the defective seal and into the module so that both the positive and negative conductor are connected to one another by the water, a short circuit capable of causing a fire, for example, can occur leading to the destruction of the diodes in the module's connection boxes.

FIGS. 1-4 show a photovoltaic module 101 known from the state of the art (hereinafter named just module 101), which encompasses a circumferential frame 2 and a composite 10 bordered by the frame 2. As is known, the composite 10 has photovoltaic cells arranged on a plane on which an EVA film has been placed and a glass panel has been mounted on the film. A Tedlar film can be applied on the underside of the cells. In this case, only the composite 10 as a whole is shown, i.e. its elements (cells, films, glass panel) are not shown in detail.

On the side of the edge, the composite 10 lies on four interconnected profile struts, the transversally running profile struts 3a, 3b and the longitudinally running profile struts 4a, 4b of the frame 2 (see FIG. 1). Here, the transversally running profile strut 3a is defined as the one that forms the horizontal bottom edge of the module 101 when the latter is placed on a sloping roof or something similar. Consequently, water hitting the module 101 runs on the glass panel towards this profile strut 3a.

In this case (see FIG. 3), the frame 2 seen in cross section has a circumferential double-walled structure, wherein the elongated side walls 5a, 5b run perpendicularly to the photovoltaic cells, and the walls 6a, 6b run perpendicularly to the side walls 5a, 5b to form a cavity 7—once again seen in cross section. In this cavity 7, angular connectors 13 for connecting two profile struts 3a, 3b and 4a, 4b arranged in each case perpendicularly to one another have been inserted into the four corner sections (see FIG. 4). The walls 6a, 6b protrude above the cavity 7 and beyond towards the interior to the middle of the frame, in which case the upper wall 6b supports the composite 10 from below (FIG. 3).

A circumferential frame leg 8, parallel and at a distance from the wall 6b, is provided on the upper side of the frame 2 to connect the wall 6b via an extension 5c of the side wall 5b. The frame leg 8, the extension 5c and the wall 6b form a circumferential trough 9, into which the composite 10 has been inserted. In a module 1 in perfect condition, there is no direct contact of the composite 10 with the above-mentioned elements 5c, 6b and 8. Rather, a seal 14 has been inserted into the trough 9, which has an essentially U-shaped cross section (see FIG. 3).

In case the seal 14 mentioned above is defective or becomes leaky over time, water penetrates into the trough 9, which can lead to frontal delamination of the composite 10 and undesired electrical short circuits or the like.

It is the task of the present disclosure to minimize the dangers described above.

### SUMMARY

This task is solved by the characteristics of the disclosed subject matter.

The advantages of the disclosed subject matter can be seen especially in that the spacing device creates a continuous path that allows water to run off along the composite surface through the spaces created. To accomplish this, the spacing device has been designed in such a way that a part of it is mounted at a distance from the at least one edge of the upper side of the composite and another part is mounted at a distance from the opposite face of the composite. Between the spacing device on the one hand, and the edge of the upper side as well as the opposite face of the composite on the other hand, a continuous path is created. Thus water, especially rainwater, cannot accumulate between the frame and the composite in case of a defective seal that could cause a ground fault or short circuit. Rather, the water can now run off to the outermost edge of the composite and down over its face to the bottom. Such path is at least preferably provided on that face of the composite that is present in the module's installed orientation, for example, on a sloping roof, on the lower edge of the module that runs horizontally.

Very preferably, from the face not bordered by the frame, an adhesive is introduced between at least two layers of the composite. The term “layers” as used here is understood to be the layer of the photovoltaic cells, one or several of the films, and/or the glass panel. The adhesive penetrates between the glass panel, the EVA layer (if present), and/or the cells to prevent water vapor, in particular, from diffusing through, thereby maintaining the composite intact over time. It also keeps the layers held together, so they do not “fray” over time. Thus, delamination can be prevented.

According to an especially advantageous embodiment, the spacing device encompasses an elongated-profile element that runs along the above-mentioned face with said separation. Naturally, it is possible to use several profile elements that follow one another and/or overlap.

It has proven to be especially advantageous if the spacing device encompasses at least one bent and/or angled profile element, preferably L-shaped, made preferably of aluminum or VA (stainless) steel.

In an L-shaped design, the first leg is preferably fastened to the frame and advantageously runs essentially at a constant distance along said face of the composite while the second leg running at a right angle to it the first leg at preferably a constant distance as well protrudes above the upper side of the edge of the composite. The resulting path provides a space for water to penetrate between the second leg and the upper side of the composite, and also afterwards between the first leg and the face. The path has a design that opens downward so water can drip off along the outer side of the frame.

The preceding embodiment has the additional advantage that the first and second legs of the L-shaped elbow mentioned above also provide UV protection for the above-mentioned adhesive applied from the face, as otherwise direct UV exposure from the sun would make it brittle over time, thus allowing humidity to penetrate into the composite. Such UV protection can be accomplished even with other bent and/or angled designs.

The spacing device is preferably fastened to at least one outer edge of a profile element of the frame, arranged below the plane in which the underside of the composite runs. Preferably, screws or rivets are used here. The frame is quite suitable for such mounting of the spacing device, as it is stable and rigid.

Preferably, the relative position and, in this case, especially the distance between the spacing device and the frame located opposite it, in whose proximity the above-mentioned face of the composite is located, is fixed in place in a defined way and one or several spacers are especially used for this purpose. For example, nuts, sleeves, washers and the like can be used. They are slid over a rivet that serves to fasten the spacing device to the frame. As a result of this, the space between the spacing device and the face of the composite opposite it is established. When an L-shaped elbow is used, the second leg does not need to be additionally fastened; rather, it is sufficient if the first leg is fastened to the profile element.

It is especially preferable if the composite is placed on the frame with its edge underneath so it does not protrude above the frame. As a result of this, secure positioning of the composite is ensured and at the same time, the face is relatively protected from frontal damage.

The disclosure also relates to a method, with which known photovoltaic elements are processed in such a way that the sections of a profile strut bordering one of the faces and the upper side of the composite are milled off to remove the seal located therein. Once this is done, a spacing device is mounted on the profile strut at a distance from the exposed upper side of the composite and at a distance from the exposed face of the composite. In this way, a continuous path is created between the spacing device on the one hand, and the upper side as well as the face of the composite on the other hand, through which water, especially rainwater, can drain off.

### BRIEF DESCRIPTION OF THE DRAWINGS

The disclosure is described in more detail in the figures, which show:

FIG. 1 is a top view of a known photovoltaic module;

FIG. 2 is a side view of the photovoltaic module of FIG. 1;

FIG. 3 is a sectional view taken along line A-A in FIG. 1;

FIG. 4 is a top view of the enlarged section B from FIG. 1;

FIG. 5 is a top view of a photovoltaic module according to certain aspects of the present disclosure;

FIG. 6 is a side view of the photovoltaic module of FIG. 5;

FIG. 7 is a sectional view taken along line A-A in FIG. 5;

FIG. 8 is a top view of the enlarged section B from FIG. 6; and

FIG. 9 is a top view of the enlarged section C from FIG. 5.

### DETAILED DESCRIPTION

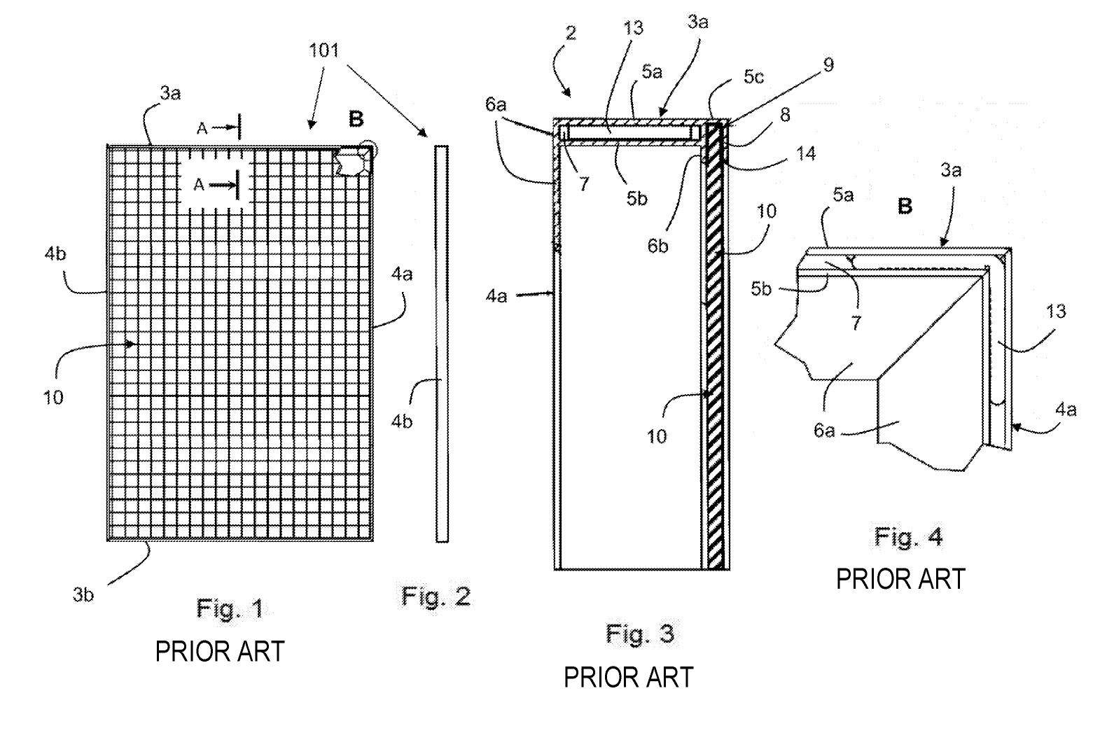

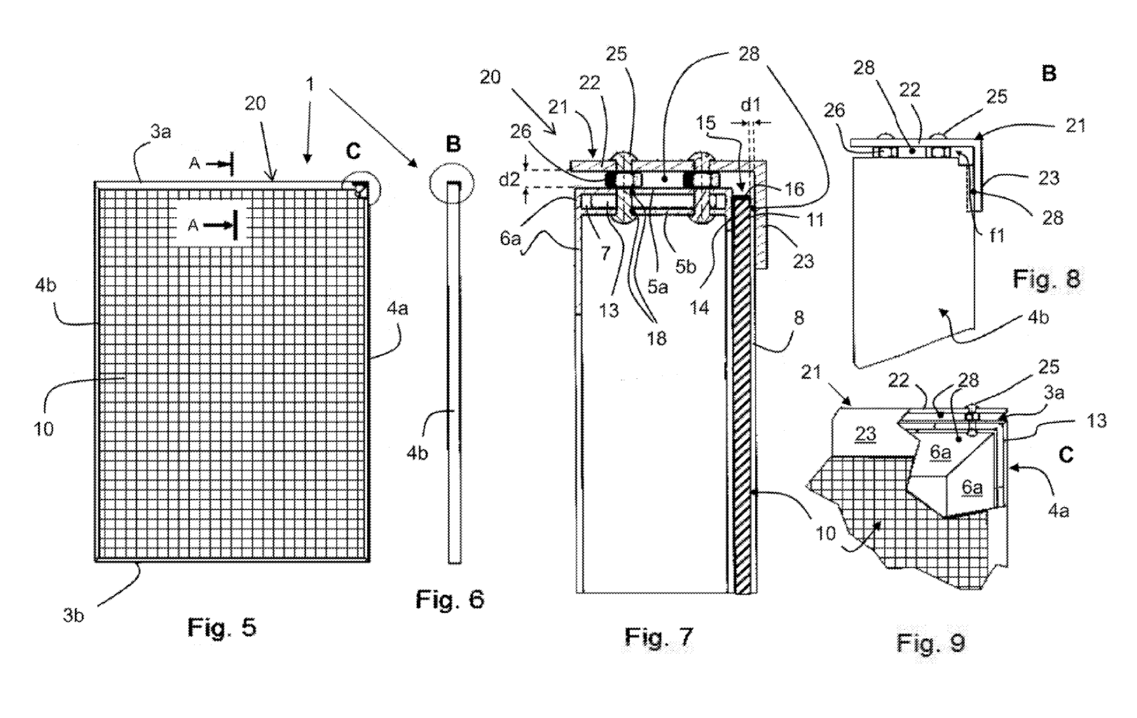

The present disclosure generally relates to a photovoltaic module 1 (or just named module 1) according to FIGS. 5-9 modified as compared to the known photovoltaic module 101 according to FIGS. 1-4. These modifications will be described initially via the process steps to be implemented, starting from module 101. To accomplish this, a known photovoltaic module 101 is prepared (the modified photovoltaic module 1 according to the disclosure receives the reference character 1, which will be used below) whose above-mentioned potential or already present weak points should be eliminated.

To start, the photovoltaic module 1 is cleaned so dirt cannot negatively impact the final result.

Afterwards, the frame 2 is milled off to remove the extension 5c and the frame leg 8 from the profile strut 3a. Additionally, the defective seal 14 located on the face 15 and the edge of the exposed upper side 11 of the composite 10 is pulled off, and the exposed face 15 of the composite 10 cleaned. Among other things, this also serves to remove the verdigris that has formed on a previously defective seal 14.

An adhesive 16 is pressed in between the glass panel, EVA layer, photovoltaic cell layer and/or Tedlar film of the composite 10 in such a way from the exposed face 15 of the composite 10 that these layers stick together and seal the face where appropriate. Thus, the layers remain firmly attached to one another and do not separate. No water vapor can penetrate either.

After the adhesive 16 has hardened, boreholes 18 suitable for receiving rivets, screws or the like (see below) are drilled in the side walls 5a and 5b of the profile strut 3a of the frame 2. In this case, two boreholes 18 have been provided below one another, whereat at least two such pairs of boreholes 18 are drilled on the two outer ends of the profile strut 3a. Such borehole pairs can also be provided, between the outer ends.

Afterwards, a spacing device 20 is mounted on the profile strut 3a at a distance d2 (see FIG. 7), for example 8 mm, from the face 15 of the composite 10. According to the embodiment shown in FIGS. 5-9, the spacing device 20 encompasses an L-shaped elbow 21 with a first leg 22 that—when the elbow 21 is mounted on the frame 2—runs parallel to the face 15 and side walls 5a, b, and a second leg 23 aligned at a right angle to the first leg 22 protrudes above the cavity 7 and the composite 10, in which case a distance d1 to the upper side 11 of the composite 10 is maintained (see FIG. 7). The distance is 1 or 2 mm, for example. The first leg 22 of the elbow 21 is fastened to the profile strut 3a by means of double rivets 25, wherein their distance d2 from one another is fixed in each case by one spacer 26 placed between them, which is shaped here like a hexagon nut.

In addition, the second leg 23 provides effective UV protection for the adhesive 16, since sunlight cannot reach the adhesive 16 directly.

The two distances d1 and d2 create a continuous path 28 between the spacing device 20 on the one hand, and the exposed upper side 11 of the composite 10 and the face 15 on the other hand, through which water running off the module 1 can penetrate. This water, which accumulates on the seal 14 of the module 101 according to the state of the art between frame leg 8 and glass panel, and which flows into the trough 9 if the seal 14 is defective, can now run off unimpeded along the face 15 of the composite 10. In other words, the trough 9 is eliminated by removing the frame leg 8 and extension 5c, whereby a continuous path 28 is created instead so water does not otherwise accumulate. The water can drain downward through the path 28 along the profile strut 3a.

In FIG. 8, which shows a side view of a section of a photovoltaic module 1 according to the disclosure, the direction that the water takes through the path 28 is indicated with an arrow f1. In the side view shown, the hidden path 28 is shown here as a dashed line.

The disclosure relates both to the method for processing existing photovoltaic modules as well as to the resulting modules themselves.

The disclosure is explained in more detail by means of the embodiment above. Variations within the claims are readily possible. Thus, it is for example possible to provide more than one face with a spacing device according to the disclosure. It is also conceivable that only one face section or several face sections of the photovoltaic module separated from one another are protected with one or several spacing devices. Instead of one L-shaped elbow, profile elements having other shapes in cross section can also be used, such as those having a partially circular cross section, for example.

### LIST OF REFERENCE CHARACTERS

1 Photovoltaic module
101 Known photovoltaic module
2 Frame
3a, b Profile strut
4a, b Profile strut
5a, b Side walls
5c Extension
6a, b Walls
7 Cavity
8 Frame leg
9 Trough
10 Composite
11 Upper side of the composite
13 Angular connector
14 Seal
15 Face
16 Adhesive
18 Boreholes
20 Spacing device
21 L-shaped elbow
22 First leg
23 Second leg
25 Double rivet
26 Spacer
28 Path

1. A photovoltaic module comprising:
a frame including profile struts;
a composite fastened to the frame, the composite having a plurality of layers, one of the layers of the composite including a plurality of photovoltaic cells and at least one of the lavers being a transparent layer located on the photovoltaic cells, the composite having an upper side and an end face;
a spacing device fastened to the frame at a first distance from the upper side and at a second distance from the end face, so as to define between the spacing device on the one hand, and the upper side and end face on the other hand, a continuous path through which water can drain.

2. A photovoltaic module according to claim 1, further including an adhesive between at least two of the layers of the composite.

3. A photovoltaic module according to claim 1, wherein the spacing device includes an elongated profile element extending along the end face at the second distance.

4. A photovoltaic module according to claim 3, wherein the spacing device has an L-shaped cross-section.

5. A photovoltaic module according to claim 4, wherein a first leg of the spacing device extends at the first distance from the upper side of the composite.

6. A photovoltaic module according to claim 1, wherein the spacing device is fastened to at least one of the profile struts of the frame with fasteners.

7. A photovoltaic module according to claim 7, further including at least one spacer between the spacing device and the frame for locating the spacing device the second distance from the end face.

8. A photovoltaic module according to claim 1, wherein the composite is supported by the frame from an underside opposite the upper side, the frame protruding past the end face of the composite toward the spacing device.

9. A method for processing a photovoltaic module having a frame including profile struts bordering a composite having a plurality of layers, one of the layers of the composite including a plurality of photovoltaic cells and at least one of the layers being a transparent layer located on the photovoltaic cells, wherein the method comprises the following steps:
milling off at least a portion of one of the profile struts to expose an end face of the composite and an adjacent portion of an upper side of the composite; and
fastening a spacing device at a first distance from the exposed adjacent portion of the upper side of the composite and at a second distance from the exposed end face of the composite, so as to create between the spacing device on the one hand, and the upper side and the end face on the other hand, a continuous path through which water can drain.

10. A method according to claim 9, further including introducing an adhesive between at least two of the layers of the composite, especially between the layer of photovoltaic cells, one or several films and/or the glass panel, from the exposed end face.

11. A method according to claim 9, wherein the spacing device has an elongated metal profile.

12. A method according to at least claim 11, wherein the spacing device has an L-shaped cross section.

13. A method according to claim 12, wherein a first leg of the spacing device extends at the first distance from the upper side of the composite.

14. A method according to claim 9, wherein the fastening step includes fastening the spacing device to one of the profile struts with fasteners.

15. A method according to claim 9, wherein the fastening step includes mounting at least at least one spacer between the spacing device and the frame in order to define the second distance.

16. A photovoltaic module according to claim 1, wherein the layers of the composite also include an EVA layer and a transparent glass panel.

17. A photovoltaic module according to claim 4, wherein the spacing device includes aluminum.

18. A method according to claim 9, wherein the layers of the composite also include an EVA layer and a transparent glass panel.

19. A method according to claim 12, wherein the spacing device includes aluminum.
